(19) United States
(12) Patent Application Publication
(10) Pub. No.: US 2006/0168642 A1
(43) Pub. Date: Jul. 27, 2006

(54) Using presence to inform other clients about capability limitations

(75) Inventors: Tetsuro Tachizawa, Tampere (FI); Zoltan Ordogh, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/270,798

(22) Filed: Nov. 8, 2005

Related U.S. Application Data
(60) Provisional application No. 60/626,330, filed on Nov. 8, 2004.

(51) Int. Cl. H04L 9/32

(52) U.S. Cl. 726/2

(57) ABSTRACT

A presence service is employed to keep track of the kinds of content types that are supported by various subscribing client devices as well as any size limitations for a given content type supported by a given device so that another client device wishing to send a message to a particular other client can consult the presence service before sending the message and determine whether the intended recipient is capable of handling the message. If not, the message is not sent and unnecessary fees for using the messaging service are avoided.

### CROSS-REFERENCE TO RELATED APPLICATION

This application claims priority from U.S. Provisional Patent Application Ser. No. 60/626,330 filed Nov. 8, 2004.

### BACKGROUND OF THE INVENTION

It is known to provide a system for adaptation of messages based on recipient's terminal capabilities and preferences as disclosed for instance in U.S. patent application Ser. No. 10/161,223 filed May 31, 2002 and published as U.S. Patent Application Publication US 2003/0236892 on Dec. 25, 2003. In that document, an SIP server preregisters capabilities and user preferences of a registering terminal after resolution by a capability negotiation manager. Subsequent receipt of an incoming message from a sending terminal indicating a message intended for the preregistered terminal causes an adaptation means to adapt the incoming message to meet the capabilities and user preferences of the preregistered terminal or transmission by the server to the preregistered terminal.

In US Patent Publication 2004/0083291 published Apr. 29, 2004, a system is shown for conveying terminal capabilities and user preference-dependent content characteristics for content adaptation (U.S. application Ser. No. 10/281,872 filed Oct. 28, 2002). In that disclosure, a system is shown where the terminal sends preferences and/or capabilities of the terminal to a server so that the server can be in a position to adapt messages intended for the terminal. Once properly adapted, the incoming message will be transmitted to the terminal in the format preferred and/or technologically recognizable at the terminal.

However, there is still a problem with situations where the message cannot be delivered because either it cannot be adapted or the intended recipient did not have the capabilities at all.

### DISCLOSURE OF THE INVENTION

An object of the present invention is to let the sender know what kind of content types can be sent to an intended recipient before sending the message in order to avoid situations where the message cannot be delivered.

According to a first aspect of the present invention, a method comprises logging in from a first client to a server with a log-in signal and after receiving a log-in response signal, sending a first client capability signal from the first client to the server including information about message content type capabilities along with size limitations of each type.

In further accord with the first aspect of the invention, said server may create or update said information about message content type capabilities along with size limitations of the first client. The server may check said information against limitation settings of the server itself and amend said information by removing unsupported content types, by setting lower size limitations, or both. The method may further comprise sending a presence update signal from said server to at least one other server with said information (which may be amended by the sending server). The at least one other server may check said information amended by said sending server against limitation settings of the at least one other server itself and may further amend said information by removing unsupported content types, by setting lower size limitations, or both. The method may further comprise said server sending a presence update signal to a second client with said information about message content type capabilities along with size limitations of the first client. The method may further comprise said server sending a presence update signal to a second client with said information of the first client as amended by the server. The method may further comprise said server sending a presence update signal to a second client with said information of the first client as amended by said server, said at least one other server, or both. The method may further comprise said second client comparing a message content type and size of a message for said first client against said information about message content type capabilities along with size limitation of the first client for deciding whether to send said message from said second client to said first client based on whether said first client is capable of receiving said message according to said message content type and size. The method may further comprising said second client comparing a message content type and size of a message for said first client against said information as amended by said server for deciding whether to send said message from said second client to said first client based on whether said first client is capable of receiving said message according to said message content type and size as amended by said server. The method may further comprise said second client comparing a message content type and size of a message for said first client against said information as amended by said server, said at least one other server, or both, for deciding whether to send said message from said second client to said first client based on whether said first client is capable of receiving said message according to said message content type and size as amended by said server, said at least one other server, or both.

According to a second aspect of the present invention, apparatus is provided comprising a device, responsive to a login signal from a user, for providing a login request signal to a server; and an own-client capability device, responsive to a login response signal, for providing a client capability request signal to said server wherein said client capability signal includes information about message content type capabilities along with size limitations of each type. The apparatus may further comprise a comparator, responsive to an own-client capability information signal from said own-client capability device and to a signal having information about capabilities of another client, for comparing device capabilities and providing a comparison signal; and a decision device, responsive to said comparison signal, for providing a decision signal for enabling a message signal to be sent to said server if said capabilities of said other client are comparable to capabilities needed to process a message contained in said message signal. The apparatus may further comprise a message transmitter responsive to said message signal, for providing an outgoing message to said server. The apparatus may further comprise a presence application, responsive to a presence update signal, for providing said signal having information about capabilities of said another client to said comparator device. The presence application may be responsive to a user input signal for providing a signal request and wherein said apparatus further comprises a presence subscribing device, responsive to said signal request signal for providing a subscribe presence signal to said server. The apparatus may further comprise a presence update device, response to said presence update signal from said server, for storing and providing a retrieved presence update signal to said presence application.

According to a third aspect of the present invention, apparatus is provided comprising a transceiver, having means responsive to a login request signal, for providing a login response signal and having means responsive to a client capability request signal for providing a client capability response signal to a client sending said login request signal and said client capability request signal. The apparatus may further comprise a client capability device, responsive to an information signal, for providing an information signal concerning type of content and size limitations associated with said type of content for storage. The apparatus may further comprise a storage, responsive to said information signal for storing said information concerning type of content a client can handle and size limitations associated with said type of content. The apparatus may further comprise a presence server, for communicating information to and from said storage, for providing a client capability change signal; and a subscription transceiver, responsive to said client capability change signal for providing a presence update signal. The subscription transceiver may be to a subscribe presence signal, for providing a subscription signal and wherein said apparatus may further comprise an add subscriber module, responsive to said subscription signal, for providing an add subscriber signal to said storage for addition of a subscriber to a subscriber database. The login device and said own-client compatibility device may comprise a client and wherein said apparatus further comprises said server having a transceiver, responsive to said login request signal, for providing said login response signal and having means responsive to said client capability request signal for providing said client capability responsive signal to said client sending said login request signal and said client capability request signal.

According to a fourth aspect of the present invention a method is provided for execution on a server, comprising receiving a login request signal from a client and sending a login response signal back to the client in response thereto, and receiving a client capability request signal from said client and sending a client capability response signal back to said client in response thereto. The method may further comprise receiving a subscribe presence signal from another client or another server and providing a status signal and a presence update signal back to said other client or other server in response thereto, and receiving a status signal from said other client or other server in response to said presence update signal. The method may further comprise said server creating or updating a client content limit attribute according to information provided by said client in said client capability request signal. The method may further comprise said server sending a presence update signal to said other server and receiving a status signal from said other server in response thereto.

According to a fifth aspect of the invention, a computer program embodied on a computer readable medium is provided for carrying out the method according to the first aspect of the invention.

According to the sixth aspect of the present invention, a computer program embodied on a computer readable medium is provided for carrying out the method according to the second aspect of the invention on said server.

According to a seventh aspect of the present invention, a computer program embodied on a computer readable medium is provided for carrying out the method according to the fourth aspect of the invention.

According to an eighth aspect of the present invention, an integrated circuit is provided for carrying out the method according to the first aspect of the invention.

According to a ninth aspect of the present invention, an integrated circuit is provided for carrying out the method according to the second aspect of the invention on said server.

According to a tenth aspect of the present invention, an integrated circuit is provided for carrying out the method according to the fourth aspect of the invention.

According to an eleventh aspect of the invention, a data structure is provided for at least temporary storage on a computer readable medium, said structure comprising a presence attribute for use by a server in maintaining client content capability information gathered during client capability negotiation and which information is for sharing with other servers which are able to limit content capabilities of any communication of content between said client and other clients according to said information so that said content can surely be delivered to said client.

Thus, a new presence attribute is defined for the purposes of the present invention, i.e., a ClientContentLimit the attribute is for being maintained by the server based on information gathered during client capability negotiation. The attribute may be made available on a per client basis. The attribute may be made mandatory, independent of authorization thus always available for the public.

Whenever this particular attribute is being delivered from the originating server towards the other end over SSP (Server-to-Server Protocol), each one of the servers that the attribute goes through verifies the included content type limitations against its own limitation settings, and makes amendment by removing or setting lower size limitations for the unsupported content type or types. This way, by the time the ClientContentLimit attribute reaches the other end, only those content types and limitations will be included that can surely be delivered.

The only disadvantage is that presence must be supported on the end where the information is required.

### BRIEF DESCRIPTION OF THE DRAWINGS

FIG. 1 shows the communication of certain information between clients and servers, according to the present invention, in order to enable the sender of a message to know what kind of content types are supported by a recipient client before deciding whether to send the message.

FIG. 2 shows an illustration of an embodiment of a client, according to the present invent.

FIG. 3 shows an embodiment of a server, according to the present invention.

### BEST MODE FOR CARRYING OUT THE INVENTION

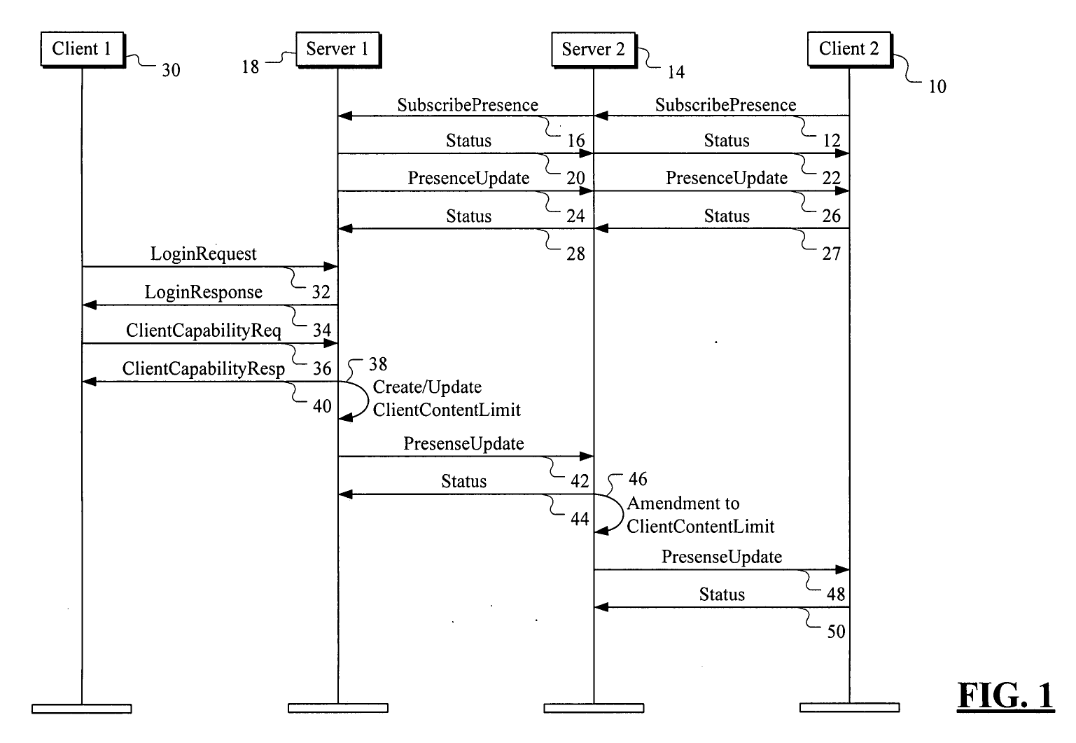

Referring now to FIG. 1, a “client 2” 10 is shown subscribing to a presence service as indicated by a subscribe presence signal on a line 12 provided to a “server 2” 14. The subscribe presence message may be similar to that described for instance in U.S. 2003/0037103 published Feb. 20, 2003. The subscribe presence signal may be forwarded on a line 16 to a “server 1” 18. A status signal on a line 20 is sent from the “server 1” 18 to the “server 2” 14 which is in turn sent from “server 2” 14 to the “client 2” 10. The status signal for instance acknowledges the receipt of the subscribe presence signal from the “client 2” 10. The “server 1” 18 may subsequently send a presence update signal on a line 24 to the “server 2” 14 which in turn sends the presence update signal on a line 26 to the “client 2” 10. This methodology serves to inform “client 2” 10 of the presence attributes of other subscribers.

According to the invention, the presence attributes include a client content limit attribute maintained by the server or servers based on information gathered during client capability negotiation such as described below. The attribute is available for a client for instance in the presence update message on the lines 24, 26 described previously. The attribute is mandatory, independent of authorization, and thus always available for the subscribers.

For instance, a “client 1” 30 is shown in FIG. 1 sending a log-in request signal on a line 32 to the “server 1” 18. In response, “server 1” 18 sends a log-in response signal on a line 34 back to “client 1” 30. The “client 1” 30 may send various responses to “server 1” 18 but one of them, according to the invention involves sending a client capability signal on a line 36 to “server 1” 18. The “server 1” 18 creates or updates 38 a client content limit attribute according to the information provided by “client 1” 30 so that the “server 1” 18 has information about the capabilities of “client 1” 30 as well as any size limits that the “client 1” 30 has imposed on content of a certain type. The client information may include information on various types of messages that “client 1” 30 is able to handle as well as information about the maximum size of the content for a given type. The “server 1” 18 may reply to “client 1” 30 with a client capability response signal on a line 40.

Once the “server 1” 18 has the client capability information of “client 1” 30, it may provide a presence update signal on a line 42 to other servers such as “server 1” 14 in the system. “Server 2” 14 is shown sending a status signal on a line 44 to acknowledge receipt of the update. “Server 2” 14 is illustrated as amending 46 the “client content limit” attribute provided by “client 1” 30 in the client capability signal on the line 36 to “server 1” 18. This presence update information is provided on a presence update signal line 48, as shown, to “client 2” 10 from “server 2” 14. “Client 2” 10 responds with a status signal on a line 50 to “server 2” 14 to indicate receipt.

“Client 2” 10 is now in a position to judge whether the message of a certain type can be sent to “client 1” 30 without having to send the message itself to the “server 2” 14 for processing there. As mentioned above, it sometimes happens that after sending such a message, the server will attempt to determine the capabilities of intended recipient client and make an adaptation if necessary. However, sometimes the adaptation cannot be carried out and this can result in a situation where “client 2” 10 is charged a fee by the service provider for sending the message from “client 2” 10 to the “server 2” 14 but the message is not delivered by the service provider and the fee is still incurred.

Thus, the goal of the present invention is achieved by letting the sender know what kind of content types can be sent to the recipient before sending the message—to avoid situations where the message cannot be delivered. The sender can then decide not to make the attempt and save money.

It should also be mentioned that during the create/update process 38 shown in FIG. 1 and also during the amendment process 46 shown as being carried out in “server 2” 14, while one of the inventive ClientContentLimit attribute is being delivered from one server towards another over the SSP protocol, each one of the servers through which the attribute transits verifies the included content type limitations against its own limitation settings and makes amendments as appropriate, for instance by removing or setting lower size limitations for unsupported content types. This way, by the time the ClientContentLimit attribute reaches a server closest to the intending sender client, only those content types and limitations will be included that can surely be delivered in the response.

The client capability negotiation can be extended with new items. Since MIME types are already negotiated, only the size limitations are missing.

If “accepted content length” is renamed to “accepted push length”, confusion is avoided as it only controls the limit for push-based delivered.

Two new terms can be defined:
AcceptedTextContentLength (this is going to be generic, only one for plain text).
AcceptedRichContentLength (this is going to be per MIME-type).

It is suggested that negotiation be kept as is—based on MIME-types instead of adopting MMS conformance classes. MMS conformance classes do not allow extensions and are not sufficient for the purpose of the present invention (separate content sizes cannot be negotiated since these are fixed in the MMS specifications).

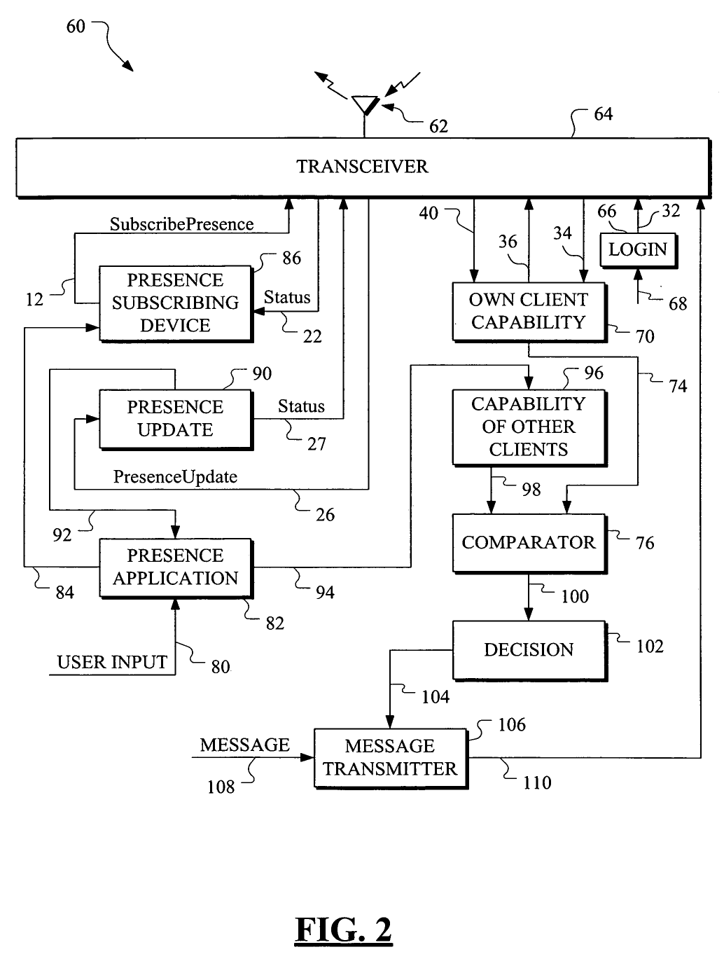

FIG. 2 shows a client such as one of the clients 10, 30 of FIG. 1. As shown in FIG. 2, the client may be a mobile device 60 including an antenna 62 for interfacing with a radio access network which in turn is in communication with a server or servers such as the servers 14, 18 of FIG. 1. The illustration of FIG. 2 is mostly functional in its description and it will be realized that the functional blocks shown in FIG. 2 can be carried out as software or hardware or some combination thereof. For instance, some or all of the blocks may take the form of an integrated circuit or be carried out as a set of coded instructions stored in a memory for execution by a signal processor. In keeping with the client 30 illustrated in FIG. 1, the device 60 of FIG. 2 includes a transceiver 64 capable of sending signals and receiving signals such as the signals 32, 34, 36 and 40 of FIG. 1. For instance, a log-in request signal on the line 32 may be sent by a log-in device 66 in response to a user initiated log-in request as illustrated by a signal on a line 68. A log-in device 66 is responsive to the log-in response signal on the line 34 from the “server 1” 18 for providing same to an own-client capability indicating device 70. In response thereto, the own client capability indicating device 70 sends the client capability request signal on the line 36 to the “server 1” 18 and is responsive to the client capability response signal on the line 40 from the server. The own client capability device 70 provides its own client capability information on a signal line 74 to a comparator 76 where information concerning the capabilities of other clients can be compared with the client's own capabilities. The information about the capabilities of other clients comes from the presence service as explained below.

It should be realized that the client 30 can also act in the role previously described for the client 10. Consequently, in such a role, in response to a user input as shown on a signal line 80, a presence application 82 provides a signal request on a line 84 to a presence subscribing device 86 which in turn provides the subscribed presence signal on the line 12 to the transceiver 64 for transmission to the “server 1” 18 via the server 14. The “server 1” 18 in turn sends the status signal on the line 20 to the “server 2” 14 which in turn sends the same status signal on the line 22 back to the client device 60 of FIG. 2. This means that the client 60 is now subscribed to the presence service. Subsequently, the presence service has received updated presence information concerning one or more other clients. It sends the presence update signal on the line 26 to the client 60 where it is provided to a presence update storage device 90 which receives and stores the updated presence information and in turn sends the status signal 27 back to the “server 2” 14 to acknowledge receipt. The presence update information received by the device 90 and stored by the device 90. The stored information may be retrieved or provided directly by the presence update device 90 on a signal line 92 to the presence application 82 for use therein and for use in providing this information on a signal line 94 to a device 96 which is able to store information concerning the capabilities of other clients. It should be realized that the functions of the presence update device 90 and the presence application 82 may be combined.

Thus, the comparator 76 is able to compare its own capabilities as represented by the information on the signal line 74 with information concerning the capabilities of another client to which the client 60 in FIG. 2 wishes to send a message. The information about the other client is obtained from the device 96 as signified by a signal on a line 98. After comparing the capabilities of the intended recipient of the message with the characteristics of the message as indicated by the capabilities of the device 60, the comparator 76 sends the results of the comparison on a signal line 100 to a decision device 102 which makes a decision whether or not the intended recipient client device should be sent the message or not. If so, a signal is provided on a line 104 to a message transmitter 106 which receives the intended message as shown on a line 108 and transmits an outgoing message on a line 110 to the transceiver 64 for transmission to the other client device.

It should be realized that the functional blocks shown in FIG. 2 can be merged with each other or possibly with other devices which are not shown. Thus, the illustration of FIG. 2 is mostly for the purpose of showing what kind of device functions would be needed to carry out the invention as shown in FIG. 1 in a client device. These can take many different forms and are not necessarily segregated into the specific blocks shown or into a presence side and a capability side as shown in FIG. 2. All of this can be merged or further segregated or aggregated as desired. For instance, the log-in device 66 and the own-client capability device 70 of FIG. 2 can be combined into an integrated circuit for carrying out the logging-in from the client to a server with the log-in signal 32 and the own-client capability device 70 for sending the first client capability signal 36 including the information about the message content type capabilities of the client along with size limitations of each type. Similarly, the same functions could be carried out by a computer program encoded with a selected encoding method and stored within the client for execution by a signal processor capable of executing code of the selected type. Such a computer program is of course embodied on a computer readable medium for carrying out such a method.

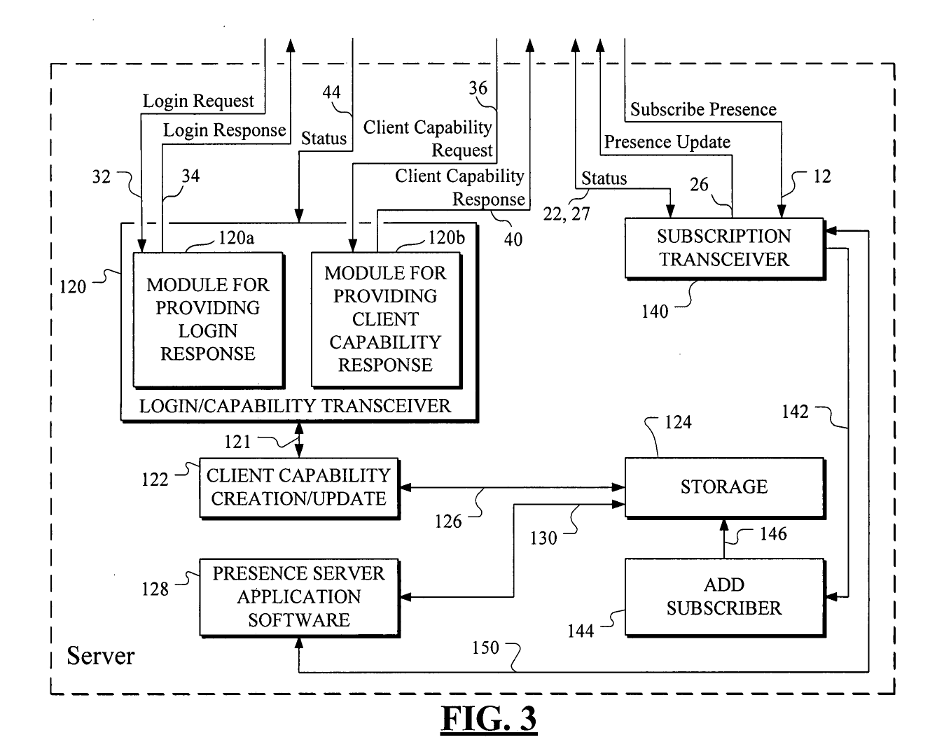

FIG. 3 shows a server such as the “server 2” 14 or the “server 1” 18 of FIG. 1. It will be noticed that the server of FIG. 3 is capable of communicating the types of signals shown between the “client 1” 30 and the “server 1” 18 as well as the types of signals shown communicated between the “client 2” 10 and the “server 2” 14 using a Client-Server Protocol (CSP) for instance. The server of FIG. 3 is also capable of communicating using the SSP with other servers so that the types of signals shown between the “server 2” 14 and the “server 1” 18 are also capable of being transmitted from or received into the server device of FIG. 3. It will be realized, however, that to prevent undo complication, the devices needed to communicate signals between “server 2” 14 and “server 1” 18 are not explicitly shown in most cases.

Referring to FIG. 3, the server device shown therein includes a log-in/capability transceiver 120 having a module 120a responsive to the log-in request signal on the line 32 from “client 1” 30. In response to the log-in request signal on the line 32, the module 120a of the transceiver 120 sends the log-in response signal on the line 34 back to “client 1” 30. After log-in, “client 1” 30 is able to send its client capability request signal on the line 36 to a module 120b of the log-in/capability transceiver 120 and a response is sent by the module 120b on the line 40 back to the “client 1” 30 from the transceiver 120. The transceiver 120 provides information on a line 121 to a client capability creation/update device 122 which is in charge of creating or updating (or both) the client content/limit information locally. In other words, the server is in charge of keeping track of the type of content that a given client can handle and any size limitations associated with a given type of content. It can store this information in a storage device 124 as shown in FIG. 3 and as communicated from the device 122 to the storage device 124 on a line 126. Presence server application software 128 is able to access the information stored on the device 124 as shown by a bi-directional signal on a line 130.

The server of FIG. 3 is also able to receive the subscribe presence signal on the line 12 of FIG. 1 in a subscription transceiver device 140. In response thereto, the status signal on the line 22 is sent back to the client. The subscription information is provided by the transceiver 140 on a signal line 142 to an add subscriber device 144 which is able to communicate on a signal line 146 with the storage device 124 for adding the subscriber to the subscriber data base stored in the storage device 124.

As a result of functionalities of the presence server application software 128, information about changes in the client capability of other clients can be communicated on a signal line 150 to the subscription transceiver 140 and communicated on the presence update signal line 26 to various presence service subscribers in the same way as shown in FIG. 1.

As was the case with the functional blocks shown in FIG. 2, the blocks shown in FIG. 3 are capable of being modified to include other functions or divided to have multiple functions carried out in multiple functional blocks. The functions illustrated are capable of being carried out in software or hardware or a combination of both. Therefore, it will be understood that the various illustrations shown in this specification are merely illustrative and the invention can be carried out in various other ways which will be appreciated by anyone of skill in the art. For instance, the log-in/capability transceiver 120 of FIG. 3 can be embodied in an integrated circuit either by itself or with any one or more of the other modules of FIG. 3, for instance the subscription transceiver, the client capability creation/update module, the presence server application software, etc. Or the functionalities can be carried out by a computer program embodied on a computer readable medium carrying out the various functions either alone or in combination. Moreover, a data structure may be maintained on the server of FIG. 3 as a presence attribute for maintaining client content capability information gathered during client capability negotiation. Such information can be shared by means of such a data structure with other servers which are able to limit content capabilities of any communication of content between the client and other clients according to the information maintained on the server so that the content can surely be delivered to the client.

Although the invention has been shown and described with respect to a best mode embodiment thereof, it should be understood by those skilled in the art that various changes, omissions and deletions in the form and detail of the foregoing may be made therein without departing from the spirit and scope of the invention.

1. Method, comprising:
logging in from a first client (30) to a server (18) with a log-in signal (32) and after receiving a log-in response signal (34),
sending a first client capability signal (36) from the first client to the server including information about message content type capabilities along with size limitations of each type.

2. The method of claim 1, further comprising said server creating or updating said information about message content type capabilities along with size limitations of the first client.

3. The method of claim 2, further comprising said server checking said information against limitation settings of the server itself and amending said information by removing unsupported content types, by setting lower size limitations, or both.

4. The method of claim 2, further comprising sending a presence update signal (24) from said server to at least one other server (14) with said information.

5. The method of claim 3, further comprising sending a presence update signal (24) from said server to at least one other server (14) with said information amended by said sending server.

6. The method of claim 5, further comprising said at least one other server checking said information amended by said sending server against limitation settings of the at least one other server itself and further amending said information by removing unsupported content types, by setting lower size limitations, or both.

7. The method of claim 2, further comprising said server sending a presence update signal (24) to a second client (10) with said information about message content type capabilities along with size limitations of the first client.

8. The method of claim 3, further comprising said server sending a presence update signal (24) to a second client with said information of the first client as amended by the server.

9. The method of claim 6, further comprising said server sending a presence update signal (24, 26) to a second client (10) with said information of the first client as amended by said server, said at least one other server, or both.

10. The method of claim 7, further comprising said second client comparing a message content type and size of a message for said first client against said information about message content type capabilities along with size limitation of the first client for deciding whether to send said message from said second client to said first client based on whether said first client is capable of receiving said message according to said message content type and size.

11. The method of claim 8, further comprising said second client comparing a message content type and size of a message for said first client against said information as amended by said server for deciding whether to send said message from said second client to said first client based on whether said first client is capable of receiving said message according to said message content type and size as amended by said server.

12. The method of claim 9, further comprising said second client comparing a message content type and size of a message for said first client against said information as amended by said server, said at least one other server, or both, for deciding whether to send said message from said second client to said first client based on whether said first client is capable of receiving said message according to said message content type and size as amended by said server, said at least one other server, or both.

13. Apparatus, comprising:
a device (66), responsive to a login signal (68) from a user, for providing a login request signal (32) to a server (18); and
an own-client capability device (70), responsive to a login response signal (34), for providing a client capability request signal (36) to said server wherein said client capability signal includes information about message content type capabilities along with size limitations of each type.

14. The apparatus of claim 13, further comprising a comparator (76), responsive to an own-client capability information signal (74) from said own-client capability device and to a signal (98) having information about capabilities of another client, for comparing device capabilities and providing a comparison signal (100); and
a decision device (102), responsive to said comparison signal, for providing a decision signal (104) for enabling a message signal (108) to be sent to said server if said capabilities of said other client are comparable to capabilities needed to process a message contained in said message signal.

15. The apparatus of claim 14, further comprising a message transmitter (106) responsive to said message signal, for providing an outgoing message (110) to said server.

16. The apparatus of claim 15, further comprising a presence application (82), responsive to a presence update signal (26, 92), for providing said signal (98) having information about capabilities of said another client to said comparator device.

17. The apparatus of claim 16, wherein said presence application is responsive to a user input signal (80) for providing a signal request (84) and wherein said apparatus further comprises a presence subscribing device (86), responsive to said signal request signal (84) for providing a subscribe presence signal (12) to said server.

18. The apparatus of claim 17, further comprising a presence update device (90), response to said presence update signal (26) from said server, for storing and providing a retrieved presence update signal (92) to said presence application (82).

19. Apparatus, comprising:
a transceiver (120), having means responsive to a login request signal (32), for providing a login response signal (34) and having means responsive to a client capability request signal (36) for providing a client capability response signal (40) to a client (30) sending said login request signal and said client capability request signal.

20. The apparatus of claim 19, further comprising a client capability device (122), responsive to an information signal (121), for providing an information signal (126) concerning type of content and size limitations associated with said type of content for storage.

21. The apparatus of claim 20, further comprising a storage (124), responsive to said information signal (126) for storing said information concerning type of content a client can handle and size limitations associated with said type of content.

22. The apparatus of claim 21, further comprising a presence server (128), for communicating information to and from said storage, for providing a client capability change signal (150); and
a subscription transceiver (140), responsive to said client capability change signal (150) for providing a presence update signal (26).

23. The apparatus of claim 22, wherein said subscription transceiver is responsive to a subscribe presence signal (12), for providing a subscription signal (142) and wherein said apparatus further comprises an add subscriber module (144), responsive to said subscription signal, for providing an add subscriber signal (146) to said storage (124) for addition of a subscriber to a subscriber database.

24. The apparatus of claim 13, wherein said login device (66) and said own-client compatibility device (70) comprise a client (30) and wherein said apparatus further comprises said server having a transceiver (120), responsive to said login request signal (32), for providing said login response signal (34) and having means responsive to said client capability request signal (36) for providing said client capability responsive signal (40) to said client (30) sending said login request signal and said client capability request signal.

25. Method for execution on a server (18), comprising:
receiving a login request signal (32) from a client (30) and sending a login response signal (34) back to the client in response thereto, and
receiving a client capability request signal (36) from said client and sending a client capability response signal (40) back to said client in response thereto.

26. The method of claim 25, further comprising:
receiving a subscribe presence signal (12, 16) from another client (10) or another server (14) and providing a status signal (20) and a presence update signal (24) back to said other client or other server in response thereto, and
receiving a status signal (28) from said other client (10) or other server in response to said presence update signal.

27. The method of claim 26, further comprising said server creating or updating a client content limit attribute according to information provided by said client (30) in said client capability request signal (36).

28. The method of claim 27, further comprising said server (18) sending a presence update signal (42) to said other server (14) and receiving a status signal (44) from said other server in response thereto.

29. Computer program embodied on a computer readable medium for carrying out the method of claim 1.

30. Computer program embodied on a computer readable medium for carrying out the method of claim 2 on said server.

31. Computer program embodied on a computer readable medium for carrying out the method of claim 25.

32. Integrated circuit for carrying out the method of claim 1.

33. Integrated circuit for carrying out the method of claim 2 on said server.

34. Integrated circuit for carrying out the method of claim 25.

35. Data structure for at least temporary storage on a computer readable medium comprising a presence attribute for use by a server in maintaining client content capability information gathered during client capability negotiation and which information is for sharing with other servers which are able to limit content capabilities of any communication of content between said client and other clients according to said information so that said content can surely be delivered to said client.
